(19) United States
(12) Patent Application Publication
(10) Pub. No.: US 2010/0318804 A1
(43) Pub. Date: Dec. 16, 2010

(54) SCHEME OF APPLYING THE MODIFIED POLYNOMIAL-BASED HASH FUNCTION IN THE DIGITAL SIGNATURE ALGORITHM BASED ON THE DIVISION ALGORITHM

(76) Inventor: Nikolajs Volkovs, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/664,176

(22) PCT Filed: Jun. 12, 2008
(86) PCT No.: PCT/CA2008/001113

§ 371 Date: Jun. 9, 2010

(30) Foreign Application Priority Data
Jun. 12, 2007 (CA) 2591280

(51) Int. Cl. H04L 9/32; H04L 9/28

(52) U.S. Cl. 713/176; 713/181

(57) ABSTRACT

The present invention relates specifically to a modified digital signature algorithm together with a polynomial-based hash function, in which the last step of the calculation of the final hash value, the exponentiation, is omitted. Such a modification eliminates some of the potential attacks to which a basic hash function algorithm is susceptible. It further introduces several flexibilities to a digital signature scheme. For example, hashing and MAC-ing procedures omit an exponentiations step, whereby the security of data is increased as the possibility of successful attack is diminished. Furthermore, the present invention may be implemented either by way of hardware or software. It may also be capable of generating a digital signature for any set of parameters extracted from a message. Generation of a digital signature may occur without the step of a hashing or MAC-ing procedure.

### FIELD OF INVENTION

The present invention relates to a modified digital signature algorithm together with a polynomial-based hash function, in which the last step of the calculation of the final hash value, the exponentiation, is omitted. Such a modification eliminates some of the potential attacks to which a basic hash function algorithm is susceptible.

### BACKGROUND OF INVENTION

Hash and Message Authentication Code (or MAC) algorithms are extremely important and, at the same time, the most vulnerable components of network security. These algorithms are used to provide a hash or MAC value that can serve as authentication of the integrity of a message that they have been appended to. A recipient user can perform the same hash or MAC operation on the received data to obtain statistical verification that the data has not been modified in transit. It should be noted that because hash and MAC algorithms produce tags of a fixed size for inputs of all lengths, the mapping is a many-to-one mapping, which results in “hash collisions”. Hash collisions result when two messages have the same hash or MAC value. Typically, a combination of the hash or MAC value and the message size is considered sufficient to provide the statistical verification. The design of the algorithms is intended to generate widely divergent hash or MAC values for slightly different inputs which provides an easy to recognize indication of message alteration. It should further be noted that MAC algorithms make use of a key in their generation of the tag. It is known that if the key is known, collisions can be easily designed to occur. This is not considered a security flaw, as the key is designed to be a secret.

In a recent development, several of the main hash algorithms (such as MD-5, RIPEMD) and hash algorithms of the SHA family (such as SHA-0, SHA-1) were somewhat compromised.

A typical secure hash function is generally referred to as an iterated hash function and is based on a proposal by Merkle (R. C. Merkle, Authentication and Public Key systems, Ph. D. Thesis, Stanford University, June 1979, and R. C. Merkle, One way hash functions and DES, in: Advances in Cryptology—Crypto '89, ed. Brassard, pp. 428-446, Lecture Notes in Computer Science 435, Springer-Verlag, 1990). According to Merkle's proposal, the hash function takes an input string of bits and partitions the string into fixed-sized blocks of size k. Then a compression function takes k bits of the i^{th} partition and m bits from the previous calculation and calculates in bits of the (i+1)^{st} iteration. The output value of the last iteration (of size m) is the hash value. One common hash function is Message-Digest algorithm 5 (MD5) which generates 1280-bit hash values. Flaws were identified in the MD5 algorithm in 1996, leading many organizations to suggest that MD5 not be relied upon as secure.

The secure hash function SHA was designed by the National Security Agency (NSA) and issued by the National Institute of Standards and Technology (NIST) in 1993 as a Federal Information Standard (FIPS-180). A revised version called SHA-1, which specifies an additional round to the message expansion, was later issued in 1995 as FIPS-180-1. Further revisions, to the SHA family of algorithms include SHA-224, SHA-256, SHA-384, and SHA-512 which are occasionally collectively referred to as SHA-2.

SHA-1 produces a 160-bit hash. That is, every message hashes down to a 160-bit string. Given that there are an infinite number of messages that hash to each possible value, there are an infinite number of possible collisions. But because the number of possible hashes is so large, the odds of finding a collision by chance is small (one in 2⁸⁰ to be exact). Thus, using the brute-force method of finding collisions, the success of the attack depends solely on the length of the hash value.

Hash and MAC functions are considered to be broken if it can be demonstrated that it is possible to find collisions using an algorithm in fewer comparisons than would be required if brute force was applied. One of the known brute force attacks directed at the SHA family involves attempting to discern the key used. With access to the key, the algorithm is compromised as it becomes much easier to design documents to have the same hash as other documents. For an m bit length key, a key attack will typically require approximately 2^{(m-1)/2} attempts to determine the key. Therefore, for a 160-bit key, any possible attack that requires less than 2⁸⁰ attempts to create a collision is considered a threat. Such a possibility has been found by Chinese cryptographers. Further details about existing hash and MAC functions can be found in chapter 9 of A. J. Menezes, P. C. van Oorschot, S. A. Vanstone, Handbook of Applied Cryptography, CRC Press, 1997.

By the recommendation of NIST, SHA-1 has been replaced by SHA-256, SHA-384, and SHA-512 (Secure Hash Signature Standard (SHS) (FIPS PUB 180-2)). However, as the algorithms SHA-1, SHA-256, SHA-384, and SHA-512 have common constructions, the same attack, that has already been used in the case of SHA-1, can be applied to SHA-256, SHA-384, and SHA-512. Furthermore, there is no guarantee that the attack will not be further enhanced. Hence, all the systems of the SHA family may eventually be compromised.

When a MAC or hashing algorithm is compromised, the conventional recommendation is to abandon the algorithm and move to a more secure algorithm. This requires that electronic infrastructure used to generate the hash or MAC values be updated, which involves moving a large installed base to another system. For obvious reasons, including user inertia, this is a difficult task. Thus, there is a need for methods, computer programs and computer systems that, while utilizing hash and MAC algorithms (such as the MAC algorithms of the SHA family), are operable to provide an improved level of security. There is a further need for the methods, computer programs and computer systems that meet the aforesaid criteria and are further easy to implement to existing technologies and are computationally feasible.

Digital signatures are a method of authenticating digital information. The output of a digital signature algorithm is a binary string (or a pair of strings) that provides authenticity, integrity and non-repudiation of the transmitted message.

Digital signature algorithms are based on public key cryptography (A. J. Menezes, P. C. van Oorschot, S. A. Vanstone, Handbook of Applied Cryptography. CRC Press, 1997) and consist of two parts: a signing algorithm and a verification algorithm.

Digital signature algorithms, such as Lamport Signatures, Matyas-Meyer Signatures, RSA Signatures, ElGamal Signatures and others, are well-known and widely-used in practice (J. Pieprzyk, T. Hardjono, J. Sebbery, Fundamentals of Computer Security, Springer-Verlag, 2003). NIST has published the Federal Information Processing Standard FIPS PUB 186, also known as the Digital Signature Standard (DSS). DSS uses SHA as the hashing algorithm together with a digital signature algorithm. digital signature algorithm is based on the difficulty of computing the discrete logarithm problem as well as on the schemes presented by ELGamal and Shnorr (J. Pieprzyk, T. Hardjono, J. Sebbery, Fundamentals of Computer Security, Springer-Verlag, 2003).

Volkovs and Murty in Canadian Patent Application No. 2,545,975 (“Patent '975”) presented a digital signature algorithm, which while also based on the difficulty of computing the discrete logarithm problem (I. F. Blake, G. Seroussi, N. Smart, Elliptic Curves in Cryptography, LMS Lecture Notes 265, Cambridge University Press, Cambridge, 2000) is, nonetheless, different from the ELGamal and the digital signature algorithm schemes. The main advantages of the digital signature algorithm of Patent '975 is the fact that it can be naturally and easily combined with a new scheme of message authentication coding with certain transformations also proposed by Volkovs and Murty (U.S. Provisional Patent Application No. 60/698,968, Canadian Patent Application No. 2,552,085, U.S. Patent Application Ser. No. 2007/0113083). Thus, in this framework, one can easily implement both a message authentication coding system (with transformations that allow generating a MAC value with sufficiently improved characteristics of security) and the proposed digital signature scheme (the digital signature algorithm of Patent '975) without any additional programming tools.

By way of background, and as noted above, a digital signature scheme is a collection of two algorithms: the signing algorithm and the verification algorithm. More particularly, the signing algorithm

SG:Γ·Δ→S

assigns a signature s to a pair d, m, where d∈F is a secret key and m∈Δ is a message, that is, SG(d, m)=s; whereas the verification algorithm

VER:Γ′·Δ·S→{t, ƒ}

uses the public key e∈Γ′ of the signer and the message m∈Δ and checks whether the pair (e, m) matches the signature s. If there is a match, the algorithm returns τ-TRUE. Otherwise, it generates -FALSE.

Using the ELGamal digital signature scheme (J. Pieprzyk, T. Hardjono, J. Sebbery, Fundamentals of Computer Security, Springer-Verlag, 2003), for example, a sender, Sally, considers a finite field GF (p), in which the discrete logarithm problem is difficult, and then selects a primitive element g∈Z*ₚ and a random integer k∈Z*ₚ, which allows computing the public key g^{k} mod p. Sally then sends g^{k}, g and p to the public registry. For a message m∈GF(p), Sally selects a random integer r∈Z*ₚ, such that gcd(r, p−1)=1, and calculates x≡g^{r} mod p. She then solves the following congruence m≡k·x+r·y mod p by y. The signature is s=SGₖ(m)=(x, y). Sally keeps secret k and r. A receiver, Bob, based on obtained message \tilde{m} and \tilde{s}=(\tilde{x}, \tilde{y}), calculates whether VER(\tilde{m}, \tilde{s})=(g^{\tilde{m}}≡(g^{k})^{\tilde{x}}·\tilde{x}^{\tilde{y}} and mod p).

On the other hand, as disclosed by Volkovs and Murty in Patent '975, a sender, based on a private key K and message x, calculates a unique pair of integers q and r such that int(K)=int(h)q+r. The sender then chooses a cyclic group G with generator g, for which the discrete logarithm problem is a hard problem and computes the public key g^{int(K)}. Finally, the sender calculates a pair (g^{q}, g^{r}), which is the digital signature of x. A receiver obtains a message y and a digital signature in a form of pair (g^{q}, g^{r}). The receiver knows a public key g^{int(K)}Then, the following two expressions are calculated g^{int(K)}(g^{r})⁻¹, (g^{q})^{int(y)}. If they match, the algorithm generates “TRUE”, otherwise, it generates “FALSE”.

In Patent '975, Volkovs and Murty further modified the digital signature algorithm as follows.

For the signing procedure, consider a message M that is hashed or MAC-ed to m. A sender chooses a private key K and a random sessional number z≠0, which is kept secret. Then, using the division algorithm, the sender calculates a unique pair of integers q and r such that

int(K)=(int(m)+z)q+r (1A)

where int(K) and int(m) are the integers whose binary presentation of which are the sequences of bits K and m, correspondingly.

A sender then chooses a cyclic group G with generator g for which the discrete logarithm problem is a hard problem, and computes the public key g^{int(K)}.

If K is k bits in size, G is a group of prime order of size 2^{α} and m is an h bit message, then it will be assumed that

max(h, k−h)<α (2A)

Finally, a pair (x, y), which is the digital signature of m, is calculated, where

x=(g^{-zq-r})

and

y=g^{q}.

If, by coincidence, zq+r is 0, it will be necessary to choose another z and recalculate the pair q and r in accordance with (1A).

A receiver obtains a message M and a digital signature in the form of a pair (x, y). The receiver also knows a public key g^{int(K)}, as well as the group G and the generator g. The message M is hashed (or MAC-ed with the corresponding key) to m′, and the following two expressions are calculated

xg^{int(K)}, y^{int(m′)}.

If they are equal, then the signature is valid. If they are not equal, the signature is not valid and the message may be rejected.

As one example, the method disclosed by Volkovs and Murty can be readily implemented in a Dynamically Linked Library (or DLL), which is linked to a computer program that utilizes an algorithm that embodies the digital signature algorithm described above, for example, an encryption, decryption or authentication utility that is operable to apply said algorithm.

The computer program disclosed by Volkovs and Murty is, therefore, best understood as a computer program that includes computer instructions operable to implement an operation consisting of the calculation of the digital signature string (pair of strings) as described above.

Another aspect of the disclosure of Volkovs and Murty, is a computer system that is linked to a computer program that is operable to implement, on the computer system, the digital signature algorithm in accordance with the present invention, together with the System of Transformation of a MAC-value in Canadian Patent Application No. 2,546,148 (“Patent '148”). Such a computer system will be of use in any environment where MAC functions are used for data integrity together with digital signatures.

As another example, the method of Volkovs and Murty can be readily implemented in a specially constructed hardware device. As discussed above, an integrated circuit can be created to perform the calculations necessary to create a digital signatures string. Other computer hardware can perform the same function. Alternatively, computer software can be created to program existing computer hardware to create digital signature values.

Volkovs and Murty in Patent '148) have also provided a secure hashing method consisting of: (1) representing an initial sequence of bits as a specially constructed set of polynomials as described herein, (2) transformation of this set by masking, (3) partitioning the transformed set of polynomials into a plurality of classes, (4) forming the bit string during the partitioning, (5) for each of the plurality of classes, factoring each of the polynomials and, so as to define a set of irreducible polynomials, collecting these factors in registers defined for each of the plurality of classes, (6) wrapping the values of the registers from the plurality of classes by means of an enumeration, (7) organizing the enumerations and the bit strings into a knapsack, and, finally, (8) performing an exponentiation in a group to obtain the hash value or the MAC value.

Because of the polynomial representation described above, in order to create a collision in accordance with the secure hash function described above, an attacker would be required to solve a collection of systems of non-linear iterated exponential equations over a finite field having specific constraints. In the case of a MAC, this difficulty is combined with the difficulty of opening the knapsack, and the difficulty of solving (a) the elliptic curve discrete logarithm referred to below, or (b) the discrete logarithm problem in the finite field, which further contributes to the security of the method of the present invention. As a result of the structure of the procedure, the resulting hash or MAC value has the following important attributes:

a) the length of the output can be changed simply by changing the final step;

b) the computation is a bit-stream procedure as opposed to a block procedure;

c) creating a collision requires the solution to several difficult mathematical problems; and

d) varying some parameters (the number of the bit strings, or the length of the bit strings, for example) allows easy variation of the difficulty of creating a collision.

The last step of the hashing method described by Volkovs and Murty in Patent '148), namely exponentiation, is performed to get the hash value of the desirable size. However, avoiding performing the exponentiation averts the possibility of two potential attacks: a “group modulo attack” and a “sum attack”.

SUMMARY OF INVENTION

In one aspect of the invention a system directed at digital signatures capable of averting attacks is characterized in that it comprises: (a) a message sent by a sender; (b) elements chosen by the sender chooses including: (i) a group of prime order; (ii) a private key; (iii) a sessional integer; and (iv) two or more primes; (c) one or more of the following elements: (i) a hashing or MAC-ing procedure utilizing elements chosen by the sender and resulting in one or more hash values; and (ii) a digital signature algorithm utilizing elements chosen by the sender and the one or more hash values; wherein attacks upon the security of the message are averted through the application of the hashing or MAC-ing procedure and the digital signature algorithm.

In another aspect of the invention a method of performing a digital signature scheme is characterized in that it comprises the following steps: (a) obtaining a message sent to a sender; (b) calculating a hash or a MAC value; (c) choosing of elements by the sender including: (i) a group of prime order; (ii) a private key; (iii) a sessional integer; and (iv) two or more primes; (d) performing a signing procedure by way of a digital signature algorithm to produce a digital signature that applies the private key, sessional integer, two or more primes and the hash or MAC value; and (e) performing a verification process for the digital signature as undertaken by a receiver.

In another aspect of the invention a computer media for performing a secure hashing or MAC-ing method is characterized in that it comprises the steps of: (a) representing an initial sequence of bits as a specially constructed set of polynomials; (b) transforming the set of polynomials by masking; partitioning the transformed set of polynomials into one or more classes; (c) forming a bit string during the partitioning step; (d) performing for each of one or more classes: (i) factoring each of the polynomials so as to define a set of irreducible polynomials; and (ii) collecting these factors in registers defined for each of the one or more classes; (e) wrapping the values of the registers from the one or more classes by means of an enumeration; and (f) organizing the enumerations and the bit strings into one or more knapsacks.

In another aspect of the invention an integrated circuit adapted to create a hash or MAC value is characterized in that it comprises performance of the steps of: (a) representing an initial sequence of bits as a specially constructed set of polynomials; (b) transforming the set of polynomials by masking; (c) partitioning the transformed set of polynomials into one or more classes; (d) forming a bit string during the partitioning step; (e) performing for each of one or more classes: (i) factoring each of the polynomials so as to define a set of irreducible polynomials; and (ii) collecting these factors in registers defined for each of the one or more classes; (f) wrapping the values of the registers from the one or more classes by means of an enumeration; and (g) organizing the enumerations and the bit strings into one or more knapsacks.

In yet another aspect of the invention a computer system is characterized in that it comprises software to program existing computer hardware to calculate the digital signature of claim 3.

Other aspects and features of the present invention will become apparent to those skilled in the art upon review of the following description of specific embodiments of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DETAILED DESCRIPTION

The present invention relates to a method and system for a modified digital signature algorithm together with a modified polynomial-based hash function, while enhancing the security of existing methods. Aspects of the present invention permit it to function so as to avert attacks that other hashing methods and digital signature schemes are susceptible to. For example, the present invention may avert attacks such as a “group modulo attack” and a “sum attack”. This is a substantial benefit of the present invention as attacks can be detrimental to the security achieved by a system.

The present invention enjoys numerous flexibilities whereby it achieves its aims. For example, the present invention may function with a hashing or MAC-ing procedure and a digital signature algorithm, or solely by way of a digital signature algorithm. In general terms, the present invention is capable of generating a digital signature for any set of parameters extracted from a message. Generation of a digital signature may occur without the step of a hashing or MAC-ing procedure. In such a case parameters extracted from a message may be signed by the digital signature algorithm of the present invention (as described below in the context of CASE B). Furthermore, in this case, the parameters may be bit strings of varying lengths.

An additional example of a flexibility of the present invention is that, should a hashing or MAC-ing procedure be included in an embodiment of the present invention, the procedure undertaken differs from the procedure of the known prior art. The hashing and MAC-ing procedures of the present invention are an improvement upon the prior art in that they do not include an exponentiation step. An exponentiation step is preformed in the context of known prior art, such as that of Patent '148, to derive a hash value of a desirable size, such that would aid the performance of the digital signature scheme. However, in creating a hash value of a desirable size, the exponentiation limits knapsacks which represent large integers, and forms instead a smaller group of bits. Thus, the additional bits, beyond those of the smaller group identified by the exponentiation step, are ignored.

In the case of a modular attack, the attacker will focus its efforts upon the first bits of a bit string of the whole of the integer. The attacker ignores the rest of the bits, which make up the collection of knapsacks. This means the attacker can focus its attack upon particular bits.

Omitting the exponentiation step is possible only through the use of the data signature algorithm of this invention. As steps in this algorithm a sender must choose two primes. The primes are chosen specifically to ensure that the construction of numbers based upon the two primes through the calculations of the algorithm will result in a value that is much larger than the hash value. The digital signature algorithm value is generated by way of an enumeration step, as described in CASE B below. Thus, an attacker will have a larger group of bits to address in the course of an attack because the digital signature algorithm value is significantly larger than the hash value. Thus, the potential effectiveness of an attack against a digital signature algorithm value is diminished because the attacker must address a greater number of bits.

Thus, omitting the performance of exponentiation offers significant benefits to a digital signature scheme. In particular, avoiding the performance of exponentiation can avert the possibility of two specific potential attacks: a “group modulo attack” and a “sum attack”.

Generally speaking, the main steps of hashing, in accordance with the algorithm in Patent '148 are: padding and splitting, masking, forming a collection of tables with bit strings, forming spectrums, calculating enumerations of the spectrums, forming knapsacks for each nᵢ, i=1, . . . , c and exponentiation. As mentioned previously, the present invention modifies the algorithm in Patent '148 by omitting the exponentiation step for the reasons already discussed and the specific examples provided below. This omission enhances the security of the present invention over that of existing methods.

In the following description, for purposes of explanation, numerous details are set forth in order to provide a thorough understanding of the present invention. However, it will be apparent to one skilled in the art that these specific details are not required in order to practice the present invention.

One embodiment of the present invention is a signing procedure involving a digital signature. In this invention, a known digital signature algorithm, as described in U.S. Patent Application No. 20080072055, may be modified to create a new digital signature algorithm.

Known existing algorithms undertake a set of steps that may begin with an identification of M as a message which is hashed or MAC-ed to m. A sender may choose a private key K and a random sessional number z≠0, which can be kept secret. Then, using the division algorithm, a unique pair of integers q and r may be calculated such that

int(K)=(int(m)+z)q+r (1)

where int (K) and int(m) are the integers whose binary representations are the sequences of bits K and m, correspondingly. A sender may then choose a cyclic group G, with generator g, for which the discrete logarithm problem is a hard problem, and computes the public key g^{int(K)}.

If K is k bits in size, G is a group of prime order of size approximately 2^{α}, and is an h-bit message, then we will assume that

max(h, k−h)<α (2)

Finally, a pair (x, y), which is the digital signature of m, may be calculated, where

x=(g^{-zq-r}) (3)

and

y=g^{q}. (4)

If, by coincidence, zq+r is 0, it is necessary to choose another z and recalculate the pair q and r in accordance with 1.

In one embodiment of the present invention a verification procedure may be undertaken whereby a receiver obtains a message M′ and a digital signature in the form of the pair (x, y). The receiver also knows the public key g^{int(K)}, the generator g, and the group G.

The message M′ may then be hashed (or MAC-ed with the corresponding key) to m′, and the following two expressions are calculated

xg^{int(K)}, y^{int(m′)}.

A detailed description of the known polynomial based hash function is presented in Patent '148. The general algorithm is modified in the present invention. The main steps of hashing include the following calculations: padding and splitting, masking, forming a collection of tables with bit strings, forming spectrums, calculating enumerations of the spectrums, and forming knapsacks for each nᵢ, i=1, . . . , c. After calculating the values of the knapsacks Vᵢ, i=1, . . . , c, we compute a final hash value in accordance with

H=gⁿ^{₁}^{V}^{₁}+gⁿ^{₂}^{V}^{₂} . . . gⁿ^{_{c}}^{V}^{_{c}}, (5)

where g is the generator of the corresponding group G of prime order of size α bits. Analyzing the expression H=gⁿ^{₁}^{V}^{₁}+gⁿ^{₂}^{V}^{₂} . . . gⁿ^{_{c}}^{V}^{_{c}}, a skilled reader may point to two ways of attacking the hash function. Firstly, an adversary may try to find a message M′ such that the corresponding values V′₁, . . . , V′_{c} satisfy the equivalences

V′ᵢ≡Vᵢ mod s, (b 6)

where s=|G|, i=1, . . . , c.

Secondly, one can combine the attack V′ᵢ≡Vᵢ mod s together with an attempt to calculate V^{j′}ᵢ different from Vᵢ for some or for all i=1, . . . , c, such that

n₁V^{i′}₁+n₂V^{j′}₂+ . . . +n_{c}V^{j′}_{c}≡n₁V₁+n₂V₂+ . . . +n_{c}V_{c} mod s.

The first attack may be described as a “group modulo attack” and the second as a “sum attack”. It is necessary to stress that these two attacks are merely two of several possibilities, it is not clear how to realize them at all. The modification of the prior known calculation of a final hash value may eliminate the potential for realizing these attacks.

Keeping in mind that the hash function is used in a framework of the digital signature scheme presented above, a new variant for processing values Vᵢ, i=1, . . . , c may be considered. However, before doing this, it may be necessary to modify the digital signature scheme, of Patent '975. In other words, in order to prevent the realization of a potential “group modulo attack” or a “sum attack”, both the final step of calculating a hash value and the digital signature algorithm may be modified.

In contrast to known algorithms, such as the digital signature algorithm of Patent '975, the newest variant of the digital signature algorithm, may include modifications such as those described below.

In addition to a private key K and a sessional secret integer z, a sender selects two primes p and w, which the sender sends to a public registry and stored in said public registry. The prime p is at least 512 bits size, while w is of size l bits, where

max(l, k−l)<α. (7)

In one embodiment of the present invention it is possible to start with group G of prime order of size α bits. Denote h=|G|.

Performing the main steps of the calculation of a hash value, the exponentiation may be omitted which means that the calculation may be completed with a collection Vᵢ, i=1, . . . , c.

Two cases exemplify this calculation.

### Case A. The Signing Procedure

It may be assumed that c=2, as this represents the most common case of the calculation of a hash value. It is possible to obtain V_{d} and V_{b}, which correspond to the situation whereby it is possible to perform solely direct and backward splitting.

Denote V′_{d}=V_{d} mod p. Setting

m=(V′^{V}^{_{b}}_{d} mod p) mod w, (8)

it may be possible compute parameters q and r in accordance with 1. After that ƒ may be calculated by

ƒ=((V′^{w} mod p) mod h)⁻¹ mod h, (9)

where V′_{b}=V_{b} mod p.

Eventually the modified digital signature pair {x, y} may be formed, where

x=g^{(-zq-r)ƒ} (10)

and

y−g^{q}. (11)

### Case A. The Verification Procedure

In one embodiment of the present invention the verification procedure is also changed from that which is known. Specifically, a receiver obtaining a message M′ and a signature (x, y) may hash M′ to obtain two values V′_{d} and V′_{b}. Then using h, p, w and g^{int(K)} from a public directory, a receiver may compute

m′=(V*^{V}^{_{b}}_{d} mod p) mod w (12)

and t in accordance with

t=((V*_{b})^{w} mod p) mod h. (13)

Here V*_{d}=V′_{d} mod p and, V*_{b}=V′_{b} mod p.

Eventually a receiver may verify whether the two values

y^{m′}, g^{int(K)}x^{t′} (14)

are equal, recalling that g^{int(K)} is a public key.

### Case B. The Signing Procedure

In another embodiment of the present invention it is possible to apply the hashing procedure and, after calculating the values of the knapsacks Vᵢ, i=1, . . . , c, compute

CE=2c_{c}(V₁, V₂, . . . , V_{c}), (15)

where c_{c} is the Cantor enumeration function, which enumerates c values V₁, V₂, . . . , V_{c}. In practice, c may equal 2 or, at most, 3 so the bit size of number CE may be roughly two or four times the size of max{V₁, . . . , V_{c}}, respectively.

Having value CE, it may be possible to compute the digital signature. The size of CE may not be fixed and may not be known before the process of hashing.

If CE>p, it may be possible to calculate the pair of unique a and b such that

CE=ap+b (16)

otherwise (if CE<p) ᵢt may be possible to calculate a and b by

p=aCE+b (17)

Notice here that, in either case, the triple p, a and b represent CE in a unique way. Moreover, as CE is not a prime neither a nor b are equal to 0.

Setting

m=(b^{a} mod p)mod w (18)

it is again possible to compute parameters q and r in accordance with 1.

Next ƒ may be calculated by

ƒ=(((a+b^{w}) mod p) mod h)⁻¹ mod h (19)

### if CE>p , and by

ƒ=(((a^{w}+b) mod p) mod h)⁻¹ mod h (20)

### if CE<p.

Eventually it may be possible to form a digital signature pair (x, y) where

x=g^{(-zq-r)ƒ} (21)

and

y=g^{q}. (22)

### Case B. The Verification Procedure

In another embodiment of the present invention it may be possible to verify the procedure of Case B whereby a receiver obtaining a message M′ and a signature (x, y) may hash M′ to obtain the collection V′₁, . . . , V′_{c} and calculate

CE′=2c_{c}(V′₁, . . . , V′_{c}).

Then, applying the division algorithm a receiver may calculate values a′ and b′ such that

CE′=a′p+b′. (23)

if p<EC′, or

p=a′CE′+b′ (24)

if CE′<p and computing

m′=(b′^{a′} mod p) mod w (25)

and t in the form of

t′=((a′+b′^{w}) mod p) mod h (26)

for the case CE>p and by

t′=((a′^{w}+b′) mod p) mod h (27)

if CE<p, a receiver may verify whether the two values

y^{m′}, g^{int(K)}x^{t′} (28)

match.

In yet another embodiment of the present invention an application may be undertaken that applies certain presumptions. For example, it may be presumed that a ₐₙd b _{are parameters} calculated by the division algorithm in accordance with CE=ap+b or p=aCE+b. Moreover, K and g^{int(K)} may be a private and a public key, respectively, and correspondingly, G may be a group of prime order h. It may further be assumed that p, w and z are the corresponding integers, that were described above and that condition 7 is satisfied. In such an instance it may be possible that the pair (g^{(-zq-r)ƒ},g^{q}), is a digital signature of CE with the following verification procedure g^{intK}g^{q})^{m}.

Since

int(K)=(m+z)g+r.

that is,

int(K)+(−zq−r)=gm

it is possible to arrive at

g^{int(K)}g^{-zq-r}=(g^{q})^{m}.

On the other hand, taking into account that)

ƒt≡1 mod h.

it is possible to finally get

g^{intK}g^{(-zq-r)ƒt}=g^{int(K)}g^{-zq-r}=(g^{q})^{m}.

In one embodiment of the present invention a generalization of a digital scheme may occur. Using the idea of signing CE presented above, the general scheme that allows generating a digital signature to a collection of data of arbitrary size may be presented. In this scheme

X₁, . . . , X_{d} (29)

may be a collection of binary strings, in general, of different size, that need to be signed. For instance, a collection of data 29 may be extracted (or computed) from a transmitted message M′ by certain algorithm.

In this manner the present invention is capable of generating a digital signature for any set of parameters extracted from a message. Generation of a digital signature may occur without the step of a hashing or MAC-ing procedure.

By presenting Xᵢ, i=1, . . . , d in a form of integers int(Xᵢ₎, binary representation of which are bit strings Xᵢ and applying the Cantor enumeration procedure, it may be possible to obtain

C=2c_{d}(int(X₁), . . . , int(X_{d})) (30)

After that the digital signature generating calculations 16-22 described above may be performed. In the case when d=1, that is, we have just one bit string X for signing, we may calculate C in accordance with

C=zint(X). (31)

To verify the signature, a receiver, obtaining a message M′ and a signature (x, y), may extract a collection of bit strings X′₁, . . . , X′_{d} (or just one bit string X) from M′, enumerate X′₁, . . . , X′_{d} to C by 30 or 31, and perform the corresponding calculations 23-28 in order to check if two values 28 match.

The size and the number of different Xᵢ, i=1, . . . , d to be signed are limited by the difficulty of calculating C.

The presented scheme is, in fact, a generalization of a digital signature algorithm, as by means of the presented scheme we can sign not just hash or MAC values of a fixed size, but also any parameter (or parameters) of any size that can be extracted, or calculated from a transmitted file without hashing them.

It is important to stress that enumerating V′₁, . . . , V′_{c}, by (15) and calculating m in accordance with (6), both a “group modulo attack” and a “sum attack” on the hash function are eliminated, since the exponentiation is not applied and the sum (5) is not formed. Besides, it is not hard to show that an adversary can apply the form (6) reduction just by modulo at least pw, which makes the “modulo attack” in that case hardly applicable as the size of pw is huge.

In other words, modifying the calculation of an input message to the digital signature algorithm, the security of the hash function is increased by eliminating two potential groups of attacks. Note also that, by selecting prime w of such size that condition (6) is satisfied, an important assumption of the digital signature algorithm is not distorted.

The presented scheme is, in fact, a generalization of a digital signature algorithm, as by means of the presented scheme we can sign not just hash or MAC values of a fixed size, but also any parameter (or parameters) of any size that can be extracted, or calculated from a transmitted file. This means that there is no need to use a hashing procedure in a framework of digital signature algorithm anymore.

Eliminating the hash function we improve the security of the digital signature algorithm. Such a scheme (signing data without hashing) will be useful in a framework of any watermarking scheme, as signing specific parameters (say some coefficients of FFT (Fast Fourier Transformation), or DCT (discrete cosine Transformation)), not a hash value of a file or a part of the file, we increase the robustness of the watermarking scheme. Signing the hash (MAC) value of a file (or a part of a file) and changing just a single bit (say, scratch) of a file we make the watermarking technique very sensitive to any modification (and useless), while in the case of just signing some parameters, (FFT, DCT coefficients) directly, we simplify the signing algorithm as we do not have a hash function any more and make the whole watermarking scheme resistant to minor modifications of a file. Indeed, even some scratches of a (image, audio file, picture, etc.) do not necessarily lead to changing the corresponding (signed) coefficients.

The method of the present invention providing the described transformation of a hash or MAC-value can be used as a universal tool as it is agnostic to the underlying hash or MAC functions, and as described above can operate on a hash or MAC value of any size. Dedicated hardware elements, including custom Application Specific Integrated Circuits (ASIC) and digital signal processors (DSP), can be used in the implementation of the present invention if high speed performance or analysis is required. Alternatively, a general purpose computer can be programmed to execute the methods of the present invention.

### Implementation

The present invention can be implemented in a number of environments where hash and MAC functions are used for both data integrity and authentication including digital signatures and certificate authentication. One example of such an implementation is in a secure electronic mail environment, where a number of applications such as Pretty-Good-Privacy (POP) encryption and Secure/Multipurpose Internet Mail Extensions (S/MIME) use MAC functions such as SHA-1 as a portion of a digital signature implementation. Another implementation environment is in Virtual Private Networks (VPN) which allows users to access a secured network over general purpose networks such as the Internet. The authentication for many VPN's relies upon protocols such as Secure Internet Protocol (IPSec) and Secure Sockets Layer (SSL). Both of these protocols make use of MAC functions such as SHA-1. Thus the vulnerability of VPN's due to the vulnerability in SHA-1 can be mitigated by use of the present invention.

Embodiments of the invention may be represented as a software product stored in a machine readable medium (also referred to as a computer-readable medium, a processor-readable medium, or a computer usable medium having a computer readable program code embodied therein). The machine readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

As one example, the method of the present invention can be readily implemented in a Dynamically Linked Library or DLL which is linked to a computer program that utilizes an algorithm that embodies the hash function or MAC function described above, for example, an encryption, decryption or authentication utility that is operable to apply said algorithm.

The computer program of the present invention is therefore best understood as a computer program that includes computer instructions operable to implement an operation consisting of the calculation of the hash value or MAC value as described above.

Another aspect of the present invention is a computer system that is linked to a computer program that is operable to implement on the computer system the transformation of a MAC-value, in accordance with the present invention.

This invention will be of use in any environment where hash functions and MAC functions are used for data integrity or authentication (digital signatures being an example).

An example is secure email. Several widely used systems for secure email (such as PGP and S/MIME) use SHA-1 as the hash algorithm.

As another example, the method of the present invention can be readily implemented in a specially constructed hardware device. Such a hardware implementation of the present invention may enable a dramatic increase in the speed of hashing, as all the hardware implementations of stream algorithms are usually much faster than the corresponding software implementations. In particular, one embodiment may apply one-chip hardware configuration.

The aspects of the present invention and embodiments thereof presented lend the invention to several applications. For example, the present invention may be applied to an online environment wherein digital signatures are routinely applied, for the purpose of ensuring the security of data passed between users. This use has practical applicability in several markets regarding the flow of electronic information, such as banking, legal, other professional businesses and trades, as well as within the public sector in government, universities, hospitals and other institutions. In these environments information is passed regularly between members by way of the Internet, Intranets and internal networks. Furthermore, as the speed of the hash function may be significantly increased when the invention is implemented by way of hardware, in such an implementation it may be possible to apply the invention to the flow of confidential information by way of methods requiring fast processing, such as video-conferencing. For example, organizations such as the military require secure and fast means of telecommunication to permit the passing of confidential information between members located distant from one another. The speed of the hash function can be very high in hardware implementations, for example, up to 4 giga-bits/second, therefore, such an implementation may provide a utile means of supporting private video-conferencing and protecting the confidential of nature of information passed therein. Furthermore, online implementations of the present invention can utilize existing signal processing providers, such as telecommunications companies like as Bell Canada™ or Rogers™, as well as private networks, to facilitate transmissions.

The above-described embodiments of the present invention are intended to be examples only. Alterations, modifications and variations may be effected to the particular embodiments by those of skill in the art without departing from the scope of the invention, which is defined solely by the claims appended hereto.

1. A system directed at digital signatures capable of averting attacks characterized in that it comprises:
(a) a message sent by a sender;
(b) elements chosen by the sender chooses including:
(i) a group of prime order;
(ii) a private key;
(iii) a sessional integer; and
(iv) two or more primes;
(c) one or more of the following elements:
(i) a hashing or MAC-ing procedure utilizing elements chosen by the sender and resulting in one or more hash values; and
(ii) a digital signature algorithm utilizing elements chosen by the sender and the one or more hash values;
wherein attacks upon the security of the message are averted through the application of the digital signature algorithm.

2. A system directed at digital signatures capable of averting attacks of claim 1 characterized in that it comprises implementation by way of either hardware or software.

3. A system directed at digital signatures capable of averting attacks of claim 1 characterized in that it comprises a hashing or MAC-ing procedure involving the steps of:
(a) representing an initial sequence of bits as a specially constructed set of polynomials;
(b) transforming the set of polynomials by masking;
(c) partitioning the transformed set of polynomials into one or more classes;
(d) forming a bit string during the partitioning step;
(e) performing for each of one or more classes:
(i) factoring each of the polynomials so as to define a set of irreducible polynomials; and
(ii) collecting these factors in registers defined for each of the one or more classes;
(f) wrapping the values of the registers from the one or more classes by means of an enumeration; and
(g) organizing the enumerations and the bit strings into one or more knapsacks.

4. A system directed at digital signatures capable of averting attacks of claim 3 characterized in that it comprises a hashing or MAC-ing procedure that averts attacks.

5. A system directed at digital signatures capable of averting attacks of claim 4 characterized in that it comprises a hashing or MAC-ing procedure that averts attacks, and specifically averts a “group modulo attack” and a “sum attack”.

6. A system directed at digital signatures capable of averting attacks of claim 1 characterized in that it comprises a digital signature algorithm that involves one or both of:
(a) a signature procedure; and
(b) a verification procedure.

7. A system directed at digital signatures capable of averting attacks of claim 6 characterized in that it comprises signature procedure involving the steps of:
(a) receiving the message and hashing or MAC-ing the message to one or more c knapsacks;
(b) enumerating the c knapsacks by way of an enumeration function to derive a CE value;
(c) applying a division algorithm to the CE value, to the private key and to the sessional integer;
(d) computing the digital signature through the one or more value results of the division algorithm; and
(e) forming a digital signature pair by way of calculations based on the values results of the division algorithm and values from a public directory.

8. A system directed at digital signatures capable of averting attacks of claim 6 characterized in that it comprises signature procedure involving the steps of:
(a) receiving the message hashing or MAC-ing it to two knapsacks;
(b) applying an operation involving two knapsacks and two primes;
(c) applying a division algorithm to result of the operation;
(d) applying a calculation to one of the two knapsacks, and to elements accessed from a public directory; and
(e) forming a digital signature pair through the application of:
(i) the one or more results of the division algorithm values;
(ii) the result of the application of the calculation to the one of the two knapsacks; and
(iii) the public directory elements.

9. A system directed at digital signatures capable of averting attacks of claim 6 characterized in that it comprises verification procedure involving the steps of:
(a) receiving two values from the sender;
(b) hashing or MAC-ing the message to one or more c knapsacks;
(c) enumerating the c knapsacks by way of an enumeration function to derive a CE value;
(d) applying a division algorithm to the CE value and to a prime value;
(e) calculating:
(i) the two values received from the sender;
(ii) the result of the application of the division algorithm; and
(iii) the public key from the public directory
so as to achieve a result of two new values;
(f) comparing the two new values to evaluate whether there is a match.

10. A system directed at digital signatures capable of averting attacks of claim 6 characterized in that it comprises verification procedure involving the steps of:
(a) receiving two values from the sender;
(b) hashing or MAC-ing the message to two knapsacks;
(c) applying an operation to the two knapsacks and to elements accessed from a public directory;
(d) calculating one or more values based on one of the two knapsacks and the public directory elements;
(e) calculating:
(i) the values from the sender;
(ii) the value of the operation;
(iii) the calculated values based on the one knapsack and the public directory elements; and
(iv) the public key from public directory
so as to result in two new values;
(f) comparing the two new values to evaluate whether there is a match.

11. A method of performing a digital signature scheme characterized in that it comprises the following steps:
(a) obtaining a message sent to a sender;
(b) calculating a hash or a MAC value;
(c) choosing of elements by the sender including:
(i) a group of prime order;
(ii) a private key;
(iii) a sessional integer; and
(iv) two or more primes;
(d) performing a signing procedure by way of a digital signature algorithm to produce a digital signature that applies the private key, sessional integer, two or more primes and the hash or MAC value; and
(e) performing a verification process for the digital signature as undertaken by a receiver.

12. A method of performing a digital signature scheme of claim 11 characterized in that it comprises the further steps for calculating a hash or MAC value:
(a) representing an initial sequence of bits as a specially constructed set of polynomials;
(b) transforming the set of polynomials by masking;
(c) partitioning the transformed set of polynomials into one or more classes;
(d) forming a bit string during the partitioning step;
(e) performing for each of one or more classes:
(i) factoring each of the polynomials so as to define a set of irreducible polynomials; and
(ii) collecting these factors in registers defined for each of the one or more classes;
(f) wrapping the values of the registers from the one or more classes by means of an enumeration; and
(g) organizing the enumerations and the bit strings into one or more knapsacks.

13. A method of performing a digital signature scheme of claim 11 characterized in that it comprises the further steps for performing a signing procedure of:
(a) receiving the message and hashing or MAC-ing the message to one or more c knapsacks;
(b) enumerating the c knapsacks by way of an enumeration function to derive a CE value;
(c) applying a division algorithm to the CE value, to the private key and to the sessional integer;
(d) computing the digital signature through the one or more value results of the division algorithm; and
(e) forming a digital signature pair by way of calculations based on the values results of the division algorithm and values from a public directory.

14. A method of performing a digital signature scheme of claim 11 characterized in that it comprises the further steps for performing a verification procedure of:
(a) receiving two values from the sender;
(b) hashing or MAC-ing the message to one or more c knapsacks;
(c) enumerating the c knapsacks by way of an enumeration function to derive a CE value;
(d) applying a division algorithm to the CE value and to a prime value;
(e) calculating:
(i) the two values received from the sender;
(ii) the result of the application of the division algorithm; and
(iii) the public key from the public directory
so as to achieve a result of two new values;
(f) comparing the two new values to evaluate whether there is a match.

15. A method of performing a digital signature scheme of claim 11 characterized in that it comprises the further steps for performing a signing procedure of:
(a) receiving the message hashing or MAC-ing it to two knapsacks;
(b) applying an operation involving two knapsacks and two primes;
(c) applying a division algorithm to result of the operation;
(d) applying a calculation to one of the two knapsacks, and to elements accessed from a public directory; and
(e) forming a digital signature pair through the application of:
(i) the one or more results of the division algorithm values;
(ii) the result of the application of the calculation to the one of the two knapsacks; and
(iii) the public directory elements.

16. A method of performing a digital signature scheme of claim 11 characterized in that it comprises the further steps for performing a verification procedure of:
(a) receiving two values from the sender;
(b) hashing or MAC-ing the message to two knapsacks;
(c) applying an operation to the two knapsacks and to elements accessed from a public directory;
(d) calculating one or more values based on one of the two knapsacks and the public directory elements;
(e) calculating:
(i) the values from the sender;
(ii) the value of the operation;
(iii) the calculated values based on the one knapsack and the public directory elements; and
(iv) the public key from public directory
so as to result in two new values;
(f) comparing the two new values to evaluate whether there is a match.

17. A method of performing a digital signature scheme of claim 11 characterized in that it comprises the further step of implementing the scheme by way of a dynamically linked library, being linked to a computer program that utilizes an algorithm that embodies the digital signature algorithm.

18. A method of creating a secure digital signature of claim 17, characterized in that it comprises the further step of implementing the digital signature algorithm by way of a computer program including computer instructions operable to implement an operation consisting of the calculation of the digital signature.

19. A method of creating a secure digital signature of claim 17, characterized in that it comprises the further steps of either:
(a) implementing the computer program as encryption;
(b) implementing the computer program as decryption; or
(c) implementing the computer program as an authentication utility.

20. A computer media for performing a secure hashing or MAC-ing method characterized in that it comprises the steps of:
(a) representing an initial sequence of bits as a specially constructed set of polynomials;
(b) transforming the set of polynomials by masking;
(c) partitioning the transformed set of polynomials into one or more classes;
(d) forming a bit string during the partitioning step;
(e) performing for each of one or more classes:
(i) factoring each of the polynomials so as to define a set of irreducible polynomials; and
(ii) collecting these factors in registers defined for each of the one or more classes;
(f) wrapping the values of the registers from the one or more classes by means of an enumeration; and
(g) organizing the enumerations and the bit strings into one or more knapsacks.

21. A computer media for performing a secure hashing or MAC-ing method of claim 20, characterized in that it comprises implementation by way of either hardware or software.

22. An integrated circuit adapted to create a hash or MAC value characterized in that it comprises performance of the steps of:
(a) representing an initial sequence of bits as a specially constructed set of polynomials;
(b) transforming the set of polynomials by masking;
(c) partitioning the transformed set of polynomials into one or more classes;
(d) forming a bit string during the partitioning step;
(e) performing for each of one or more classes:
(i) factoring each of the polynomials so as to define a set of irreducible polynomials; and
(ii) collecting these factors in registers defined for each of the one or more classes;
(f) wrapping the values of the registers from the one or more classes by means of an enumeration; and
(g) organizing the enumerations and the bit strings into one or more knapsacks.

23. An integrated circuit adapted to create a hash or MAC value of claim 22, characterized in that it comprises implementation by way of either hardware or software.

24. A computer system characterized in that it comprises software to program existing computer hardware to calculate the digital signature of claim 11.
